(19) United States
(12) Patent Application Publication
(10) Pub. No.: US 2013/0012350 A1
(43) Pub. Date: Jan. 10, 2013

(54) WHEEL HUB DRIVE FOR MOTOR VEHICLES

(75) Inventor: Philipp Ebner, Graz (AT)

(73) Assignee: MAGNA POWERTRAIN AG, Lannach (AT)

(21) Appl. No.: 13/578,689

(22) PCT Filed: Feb. 14, 2011
(86) PCT No.: PCT/EP2011/052121

§ 371 Date: Aug. 17, 2012

(30) Foreign Application Priority Data
Feb. 12, 2010 (DE) 102010007758.5

(51) Int. Cl. B60K 17/14

(52) U.S. Cl. 475/149

(57) ABSTRACT

The invention relates to a wheel hub drive for a motor vehicle, having a motor, in particular an electric motor, which is connected to an input element of a transmission so as to exercise a driving effect, wherein the transmission has an output element, which is connected to a shaft section, by means of which a wheel of the motor vehicle can be driven. A sensor is furthermore provided for monitoring the rotational speed of the drive, comprising a sensor element arranged in a manner fixed against rotation and a rotatable sensor element. The rotatable sensor element is connected to the output element for conjoint rotation.

### CROSS-REFERENCE TO RELATED APPLICATIONS

The present application is a National Stage Application of PCT International Application No. PCT/EP2011/052121 (filed on Feb. 14, 2011), under 35 U.S.C. §371, which claims priority to German Patent Application No. 10 2010 007 758.5 (filed on Feb. 12, 2010), which are each hereby incorporated by reference in their respective entireties.

### FIELD OF THE INVENTION

The present invention relates to a wheel hub drive for motor vehicles.

### BACKGROUND OF THE INVENTION

In conventional motor vehicles, there is generally a drive unit at the front or rear in the center of the vehicle. The torque produced by the drive unit is transmitted to driven wheels of the motor vehicle by universally jointed shafts. A drive line of this kind takes up a considerable amount of installation space, which cannot be used for other components of the motor vehicle.

Wheel hub drives represent compact alternative drives. Each driven wheel is assigned a dedicated drive situated in the region of the wheel hub. Expensive components for transmitting the drive torque of a drive unit to the driven wheels are therefore eliminated. The installation space, which is no longer required, can be used by other vehicle components. In electric or hybrid vehicles, a battery can be arranged in the space that has become available, for example.

Wheel hub drives are generally arranged close to the wheel bearings. In certain cases, the wheel bearings may even be integrated into the wheel hub drives associated with them. The result of this is that the installation space available in the region of the wheel bearing is restricted. Assemblies that are generally arranged in the region of the wheel bearing must therefore be positioned differently or even redesigned. For example, rotational speed sensors (e.g. for antilock brake systems) used hitherto cannot readily be arranged directly behind the wheel bearing, as is common practice with conventional drives.

### SUMMARY OF THE INVENTION

It is therefore an object of the present invention to create a wheel hub drive which provides a solution for the problems discussed above that is optimized in terms of installation space.

The object stated above is achieved by a wheel hub drive for a motor vehicle, having a motor, in particular an electric motor, which is connected to an input element of a transmission so as to exercise a driving effect. The transmission includes an output element which is connected to a shaft section, and by which a wheel of the motor vehicle is driven. A sensor is provided for monitoring the rotational speed of the drive, and includes a sensor element arranged in a manner fixed against rotation and a rotatable sensor element connected to the output element for conjoint rotation.

The wheel hub drive for a motor vehicle in accordance with the invention has a motor, in particular an electric motor, which is connected to an input element of a transmission so as to exercise a driving effect. The transmission has an output element, which is connected to a shaft section, and by which a wheel of the motor vehicle is driven. A sensor is provided for monitoring the rotational speed of the drive, and includes a sensor element arranged in a manner fixed against rotation and a rotatable sensor element. The rotatable sensor element is connected to the output element for conjoint rotation.

In other words, a solution in accordance with the invention makes use of the fact that the output element of a transmission, which is arranged between the torque-producing motor and a driven wheel, rotates at the same speed as the driven wheel. The sensor, therefore, does not measure the rotational speed of the wheel directly in the region of the wheel bearing, but is associated with the output element of the transmission. As a result, the unit that includes the motor, the transmission and the sensor is simple to assemble. Moreover, the sensor can be provided at more easily accessible locations.

The transmission in accordance with the invention is preferably a planetary transmission, the output element of which is a planet carrier. Transmissions of this kind are compact and reliable.

The rotatable sensor element can be arranged in the region of an outer circumference of the output element in order to have as large as possible a radius, thereby making it possible to determine the rotational speed of the output element precisely and in a simple manner.

In accordance with the invention, advantageously a wheel bearing section is provided to support the shaft section connected to the output element. In such an embodiment, the outer circumference of the output element is larger than the outer circumference of the shaft section rotatably supported by the wheel bearing section. In particular, the outer circumference of the output element is also larger than the respective outer circumferences of further components connected to the shaft section for conjoint rotation. Since the intention is to measure the rotational speed at the transmission and not at a shaft or a comparable component, recourse is had to an output element associated with the transmission, which can be a planet carrier, for example, for monitoring the rotational speed, the output element generally having a larger outer circumference than a shaft section by which the output torque of the transmission is fed to the wheel.

Provision can furthermore be made for the shaft section to be formed integrally with the output element. A two-part design, however, is also possible.

The transmission in accordance with the invention can be arranged in a housing or housing section which can be closed by way of a cover. It has proven advantageous if the sensor element fixed against rotation is arranged on the cover and, in particular, extends at least partially from the outside into the interior of the housing through an opening in the cover. This allows simple mounting of and access to the sensor.

Further embodiments of the invention are indicated in the dependent claims, the description and the attached drawings.

### BRIEF DESCRIPTION OF THE DRAWINGS

Advantageous refinements of the invention will emerge from the dependent claims. An exemplary embodiment of the invention will be discussed in principle below on the basis of the drawing, in which:

FIG. 1 illustrates a cross-sectional view of a wheel hub drive in accordance with the invention.

FIG. 2 illustrates a perspective view of a planetary transmission of the wheel hub drive of FIG. 1.

### DETAILED DESCRIPTION OF EMBODIMENTS

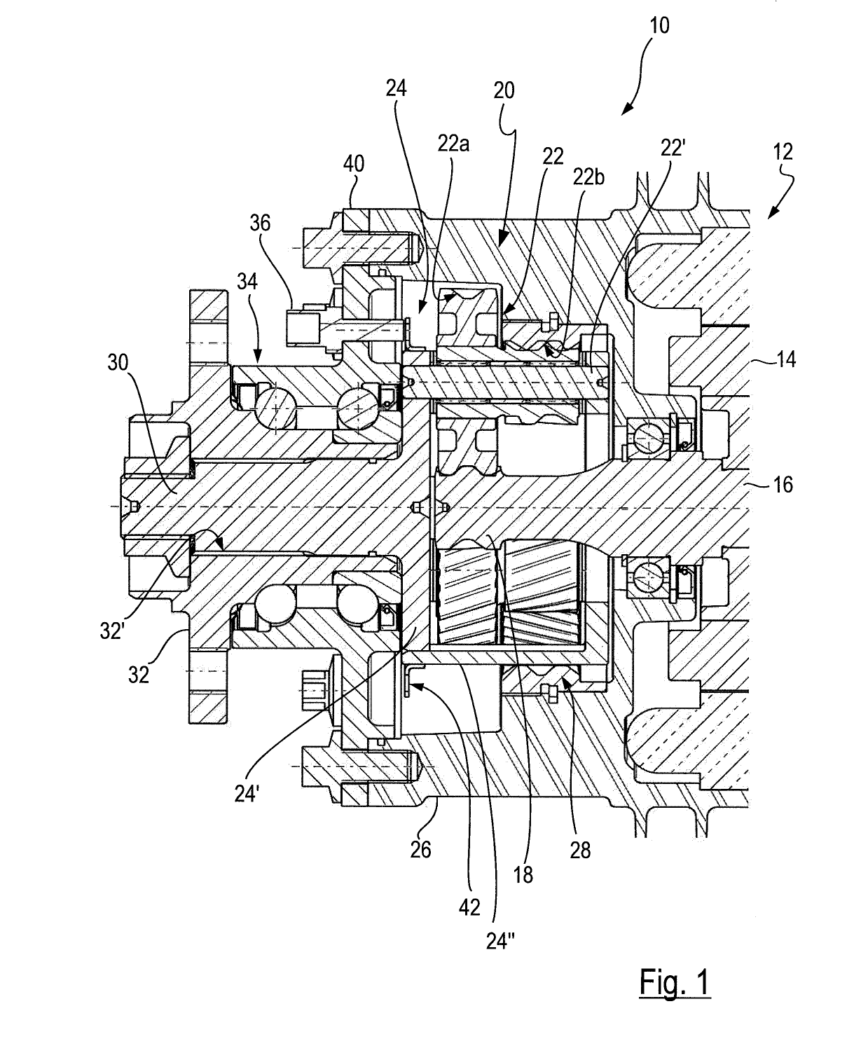

FIG. 1 illustrates a wheel hub drive 10, which includes an electric motor 12 illustrated in an only rudimentary way and not described further. A rotor 14 of the electric motor 12 is connected to a drive shaft 16 for conjoint rotation. The drive shaft 16 carries a sun wheel 18 of a planetary transmission 20, which in turn meshes with a toothed section 22a of a stepped planet 22. The toothed section 22a is connected for conjoint rotation to a further toothed section 22b of the stepped planet 22. When the stepped planet 22 is driven by the sun wheel 18, a rotary motion of a planet carrier 24 carrying the stepped planet 22 is produced since the toothed section 22b rolls on an annulus 28 rigidly connected to a housing 26.

The planet carrier 24 forms the output element of the planetary transmission 20, and includes a base 24′ and a cage 24″, which contributes to the support of a planet axle 22′ carrying the stepped planet 22. The base 24′ of the planet carrier 24 is formed integrally with a shaft section 30 which, in turn, is connected to a flange 32 for conjoint rotation by means of splines 32′. The flange 32 is used for attachment of a rim (not illustrated) of a wheel of a motor vehicle. The shaft section 30 and the flange 32 connected thereto are rotatably supported by a wheel bearing 34.

As further illustrated, the installation space between the flange 32 and the planetary transmission 20 is very narrowly dimensioned. Moreover, since the wheel bearing 34 is arranged in this area, it is not easy to determine the rotational speed of the shaft section 30. Accordingly, a sensor element 36 is arranged on a cover 40 of the housing 26, and projects through an opening in the cover 40 into the interior of a section of the housing 26 which accommodates the planetary transmission 20. There, the sensor 36 measures a speed of rotation of a transmitter ring 42, which is attached to the circumference of the planet carrier 24, e.g., by adhesive bonding or press fitting. Owing to the fact that the outside diameter of the planet carrier 24 is relatively large in comparison with the diameter of the shaft section 30 and of the flange 32, the rotational speed can be determined precisely in a simple manner.

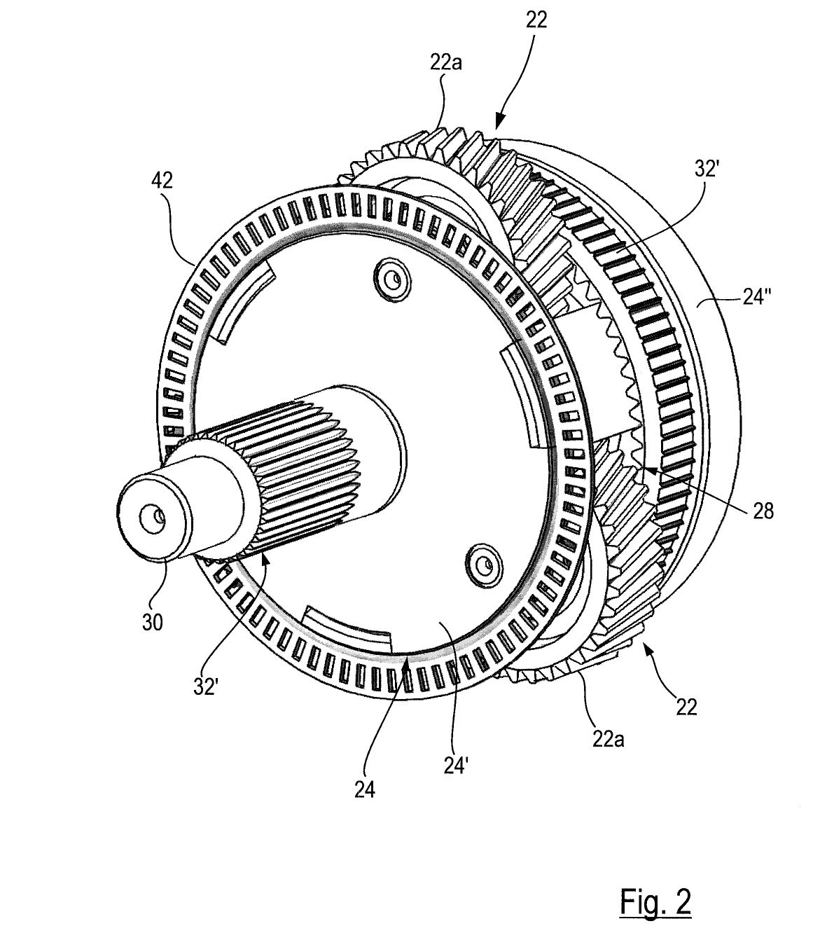

FIG. 2 illustrates a perspective view of the planetary transmission 20 of the wheel hub drive 10. Three stepped planets 22 are provided (although only two are illustrated). The transmitter ring 42 is a perforated ring element, which is attached to the circumference of the planet carrier 24 and is therefore easily accessible. It is also possible for means that correspond in terms of function to the transmitter ring 42 to be formed directly on the planet carrier 24. FIG. 2 furthermore illustrates that the annulus 28 has splines 32′ on the circumference, which are used to fix the annulus 28 in the housing 26 in a manner fixed against rotation.

In accordance with the invention, the basic principle of measuring the rotational speed of the wheel at an output element of a transmission is not restricted to planetary transmissions. The mode of operation of the sensor is likewise a matter of choice (e.g., active/passive construction) as long as at least one rotatably supported sensor element is provided which is attached to the output element of the transmission. Furthermore, in contrast to the construction illustrated in FIGS. 1 and 2, the output element of the transmission (in this case the planet carrier 24 or parts thereof) does not have to be formed integrally with the shaft section 30 in order to implement the concept underlying the invention.

In principle, it is also possible not to arrange the transmitter ring 42 in the region of the base 24′ of the planet carrier 24, but to position it at the right-hand end of the cage 24″ in FIG. 1, for example. In this case, the sensor element 36 would then have to be inserted through the circumferential wall of the housing 26 at the appropriate point from above or below in order to be able to interact with the transmitter ring 42 or with a functionally similar element.

### LIST OF REFERENCE NUMERALS

10 wheel hub drive

12 electric motor

14 rotor

16 drive shaft

18 sun wheel

20 planetary transmission

22 stepped planet

22′ planet axle

22a, 22b toothed section

24 planet carrier

24′ base

24″ cage

26 housing

28 annulus

30 shaft section

32 flange

32′ splines

34 wheel bearing

36 sensor element

40 cover

42 transmitter ring

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1-6. (canceled)

7. A wheel hub drive for a motor vehicle, the wheel hub drive comprising:
a shaft;
a wheel bearing section which rotatably supports the shaft;
a planetary transmission having a planet carrier operatively connected to the shaft and by which a wheel of the motor vehicle is driven;
a housing in which the planetary transmission is arranged, the housing having a cover which closes an opening of the housing; and
an electric motor connected to an input element of the planetary transmission so as to exercise a driving effect; and
a sensor configured to measure a rotational speed of the wheel hub drive, the sensor having a first sensor element arranged in a manner fixed against rotation and a second sensor element operatively connected to the planet carrier for conjoint rotation therewith.

8. The wheel hub drive of claim 7, wherein the second sensor element is provided in a region of an outer circumference of the planet carrier.

9. The wheel hub drive of claim 7, wherein the outer circumference of the planet carrier is greater than the outer circumference of the shaft.

10. The wheel hub drive of claim 7, wherein the outer circumference of the planet carrier is greater than respective outer circumferences of further components connected to the shaft section for conjoint rotation.

11. The wheel hub drive of claim 7, wherein the shaft is formed integrally with the planet carrier.

12. The wheel hub drive of claim 7, wherein the first sensor element is arranged on the cover.

13. The wheel hub drive of claim 12, wherein the first sensor element extends at least partially into the interior of the housing through an opening in the cover.

14. A wheel hub drive for a motor vehicle, the wheel hub drive comprising:
a shaft;
a transmission having an input element and an output element operatively connected to the shaft by which a wheel of the motor vehicle is driven;
a motor connected to the input element; and
a sensor configured to monitor a rotational speed of the wheel hub drive, the sensor having a first sensor element arranged in a manner fixed against rotation and a second sensor element operatively connected to the output element for conjoint rotation therewith.

15. The wheel hub drive of claim 14, wherein the transmission comprises a planetary transmission.

16. The wheel hub drive of claim 14, wherein the output element of the transmission comprises a planet carrier.

17. The wheel hub drive of claim 14, wherein:
the transmission comprises a planetary transmission; and
the output element of the transmission comprises a planet carrier.

18. The wheel hub drive of claim 14, wherein the second sensor element is provided in a region of an outer circumference of the output element.

19. The wheel hub drive of claim 14, further comprising a wheel bearing section which rotatably supports the shaft section connected to the output element.

20. The wheel hub drive of claim 19, wherein the outer circumference of the output element is greater than the outer circumference of the shaft section rotatably supported by the wheel bearing section.

21. The wheel hub drive of claim 14, wherein the outer circumference of the output element is greater than respective outer circumferences of further components connected to the shaft section for conjoint rotation.

22. The wheel hub drive of claim 14, wherein the shaft is formed integrally with the output element.

23. The wheel hub drive of claim 14, further comprising a housing in which the transmission is arranged, the housing having a cover which closes the housing.

24. The wheel hub drive of claim 14, wherein the first sensor element is arranged on the cover.

25. The wheel hub drive of claim 24, wherein the first sensor element extends at least partially into the interior of the housing through an opening in the cover.

26. The wheel hub drive of claim 14, wherein the motor comprises an electric motor.
